(19) United States
(12) Patent Application Publication
(10) Pub. No.: US 2007/0274592 A1
(43) Pub. Date: Nov. 29, 2007

(54) Method of generating image provided with face object information, method of correcting color, and apparatus operable to execute the methods

(75) Inventor: Masatoshi Matsuhira, Matsumoti-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/704,396

(22) Filed: Feb. 9, 2007

(30) Foreign Application Priority Data
Feb. 10, 2006 (JP) P.2006-034603

(51) Int. Cl. G06K 9/46

(52) U.S. Cl. 382/190

(57) ABSTRACT

Image data including an object is generated by capturing an image. The object included in the image data is recognized automatically. Information regarding the object is extracted automatically. The information regarding the object is associated with the image data after a storing operation of the image data is instructed.

### BACKGROUND

1. Technical Field

The present invention relates to an image processor comprising a recognizer for a face object in a captured image, a digital camera equipped with the image processor, an image data structure of an image provided with face object information, an image processor for making color correction based on the face object information, a printer having an automatic color correcting function and equipped with the image processor, a method of generating the captured image provided with the face object information, and a method of correcting color based on the face object information, and more particularly, to a technique for correcting color of an image captured with improper exposure and for printing the corrected image.

2. Related Art

In recent years, printers which can directly print captured images inputted externally and specified by a user without using a computer have been in the market.

As an example of such printers, there is a printer that has a port into which a memory detachably equipped in a digital camera can be inserted, and prints a captured image stored in the memory inserted into the port. As another example, there is a printer that has a communication port which receives a captured image from a communication port of a digital camera, and prints the received captured image.

However, when a user captures an image including a person with a digital camera, there are some cases where exposure is improper (typically excessive exposure or insufficient exposure) when a captured region (including an object area and other areas) is irradiated with direct sunlight or strong illumination. When an image captured with the improper exposure is printed by the above-described printer (which directly receives the captured image), the captured image entirely shows unnatural color.

Of course, the image captured with the improper exposure may be inputted to a computer and then printed after being subjected to color correction in the computer. However, it is generally not easy for persons inexperienced in photo retouch to make such computer-based color correction. On this account, in most cases, the image captured with the improper exposure is forced to be printed as it is without being subjected to computer-based color correction.

Under such circumstances, there has been proposed a printer with a color correcting function, which is capable of extracting a face object (a face of a person in a captured image) from a captured image inputted to the printer and correcting color of the entire captured image so that color of the face object matches with color of the face.

However, a heavy (great quantity of) arithmetic processing is required to extract the face object from the captured image. Typically, a CPU equipped in a printer has no performance of recognizing a face object in a captured image at a high speed. On this account when a printer with the conventional correcting function performs a series of processings for recognizing the face object in the captured image and color-correcting the captured image so that the color of the face object matches with the color of the face, it may take a long time period (beyond time acceptable by a user) from when a user instructs the printer to start a printing operation to when the printer actually starts the printing operation.

### SUMMARY

It is therefore one advantageous aspect of the invention to provide an image processing method of generating a captured image provided with face object information, which is capable of correcting color of an image captured with improper exposure at a high speed in a printer, and to provide an apparatus operable to perform the method.

According to one aspect of the invention, there is provided a method of generating image data, comprising:

generating image data including an object by capturing an image;

recognizing the object included in the image data automatically;

extracting information regarding the object automatically; and

associating the information regarding the object with the image data after a storing operation of the image data is instructed.

The object may be a face.

The information may be either information indicative of a position of the object in the image or information indicative of color of the object.

The method may further comprises storing the image data with which the information has been associated in a removable memory.

According to one aspect of the invention, there is provided an image processor, comprising:

an data acquirer, operable to acquire original image data;

a recognizer, operable to recognize a face object included in the original image data;

an information extractor, operable to extract either position information of the face object or color information of the face object, as face object information; and

a data generator, operable to generate image data by either attaching the face object information to the original image data or burying the face object information in the original image data.

According to one aspect of the invention, there is provided a color correction method, comprising:

acquiring an image to be processed;

judging whether color information of a face object is attached to or buried in the image; and

applying color correction to the image based on the color information in a case where it is judged that the color information is attached to or buried in the image.

In a case where there are a plurality of face objects, the color correction may be applied based on the respective color information attached to the face object.

The image may be acquired from a removable memory.

### BRIEF DESCRIPTION OF THE DRAWINGS

FIG. 1A is a functional block diagram showing an image processor for generating a captured image provided with face object information, according to a first embodiment of the invention.

FIG. 1B is a functional block diagram showing a digital camera equipped with the image processor of FIG. 1A.

FIG. 2A is a functional block diagram showing an image processor for color correction, according to the first embodiment of the invention.

FIG. 2B is a functional block diagram showing a printer equipped with the image processor of FIG. 2A.

FIG. 3 is a flowchart showing a method of generating the image provided with the face object information, according to the first embodiment of the invention.

FIG. 4 is a flowchart showing a method of correcting color of the image provided with the face object information, according to the first embodiment of the invention.

FIG. 5A is a functional block diagram showing an image processor for generating a captured image provided with face object information, according to a second embodiment of the invention.

FIG. 5B is a functional block diagram showing a digital camera equipped with the image processor of FIG. 5A.

FIG. 6A is a functional block diagram showing an image processor for color correction, according to the first embodiment of the invention.

FIG. 6B is a functional block diagram showing a printer equipped with the image processor of FIG. 6A.

FIG. 7 is a flowchart showing a method of generating the image provided with the face object information, according to the second embodiment of the invention.

FIG. 8 is a flowchart showing a method of correcting color of the image provided with the face object information, according to the second embodiment of the invention.

FIG. 9A is a functional block diagram showing an image processor for generating a captured image provided with face object information, according to a third embodiment of the invention.

FIG. 98 is a functional block diagram showing a digital camera equipped with the image processor of FIG. 9A.

FIG. 10A is a functional block diagram showing an image processor for color correction, according to the third embodiment of the invention.

FIG. 10B is a functional block diagram showing a printer equipped with the image processor of FIG. 10A.

FIG. 11 is a flowchart showing a method of generating the image provided with the face object information, according to the third embodiment of the invention.

FIG. 12 is a flowchart showing a method of correcting color of the image provided with the face object information, according to the third embodiment of the invention.

### DETAILED DESCRIPTION OF EXEMPLARY EMBODIMENTS

Exemplary embodiments of the invention will be described below in detail with reference to the accompanying drawings.

First, a first embodiment of the present invention will be described.

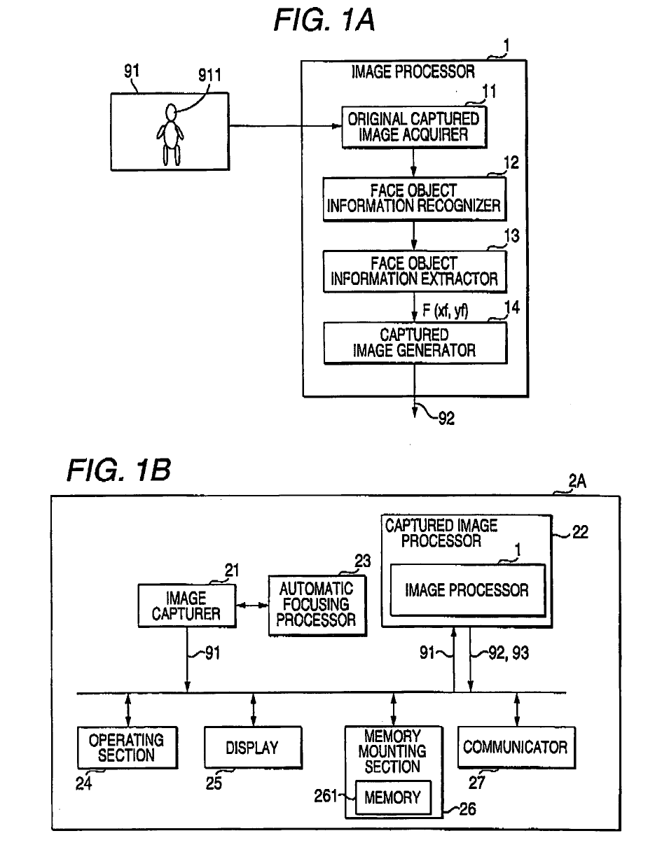

As shown in FIG. 1A, an image processor 1 for generating a captured image provided with face object information comprises an original captured image acquirer 11, a face object recognizer 12, a face object information extractor 13, and a captured image generator 14.

For example if the image processor 1 is equipped in a digital camera, the original captured image acquirer 11 can acquire an original captured image from an image capturer 21 of a digital camera 2A (see FIG. 1B).

The face object recognizer 12 can recognize a face object 911 of a person in the original captured image 91.

The face object information extractor 13 can extract position information (F(xf, yf) in this embodiment) of the face object 911 on the original captured image 91.

If a plurality of face objects exists in the original captured image 91, the position information F(xf, yf) may be plural in number, or only a center coordinate of a face object having the greatest area may be set as the position information F(xf, yf).

In this embodiment, the position information may be the center coordinate F(xf, yf) of the face object, block information including a group of rectangular blocks on the face object, or figure information (rectangle, circle, ellipsoid, triangle, polygon, etc.) centered at the center coordinate of the face object. In addition, as illustrated in a third embodiment which will be described later, the position information may be contour information G(xg, yg) of the face object.

The captured image generator 14 can generate a captured image 92 provided with face object information in which the position information F(xf, yf) is attached to or buried in the original captured image 91.

As shown in FIG. 1B, the image processor 1 includes the image capturer 21, a captured image processor 22, an automatic focusing processor 23, an operating section 24, a display 25, a memory mounting section 26, and a communicator 27.

The image capturer 21 may be an imaging device such as a CCD to generate the original captured image 91. The captured image processor 22 includes the image processor 1 to create the captured image 92 provided with face object information or a normal captured image 93, such as a JPEG format image, from the original captured image 91 generated by the image capturer 21.

The automatic focusing processor 23 can recognize a face object of a person in the original captured image 91 and focus on the person. Techniques of storing a layout sample of a feature such as eyes, eyebrows, a nose, a mouth and so on, and a contour sample of a face in a database, scanning an original captured image in a real time manner, and measuring a position of the face and a distance to the face in order to recognize a face object have been known in the art, and therefore, explanation of which will be omitted for the sake of avoiding complexity of description.

The operating section 24 includes a shutter, a power switch, a storage key, a mode setting key, etc. The mode setting key is used to set an image capturing mode, an editing mode, etc.

The display 25 displays an image captured by the image capturer 21 in the image capturing mode (captured image) in a real time manner.

The memory mounting section 26 is mounted with a memory 261 that stores the original captured image 91. Ancillary information such as an image capturing date in a header of the original captured image 91 may be included in the captured image 92 or 93.

The communicator 27 can output the captured image 92 as data. Although it is illustrated in this embodiment that the digital camera 2A comprises both of the memory mounting section 26 and the communicator 27, the digital camera 2A, the digital camera 2A may comprise either the memory mounting section 26 or the communicator 27.

The position information (the coordinate F(xf, yf)) is written into a header of the captured image 92 provided with face object information. The position information F(xf, yf) is a coordinate on the original captured image 91 of the face object 911. The captured image 92 provided with face object information is an image in which the position information F(xf, yf) is buried as a digital watermarking in the original captured image 91.

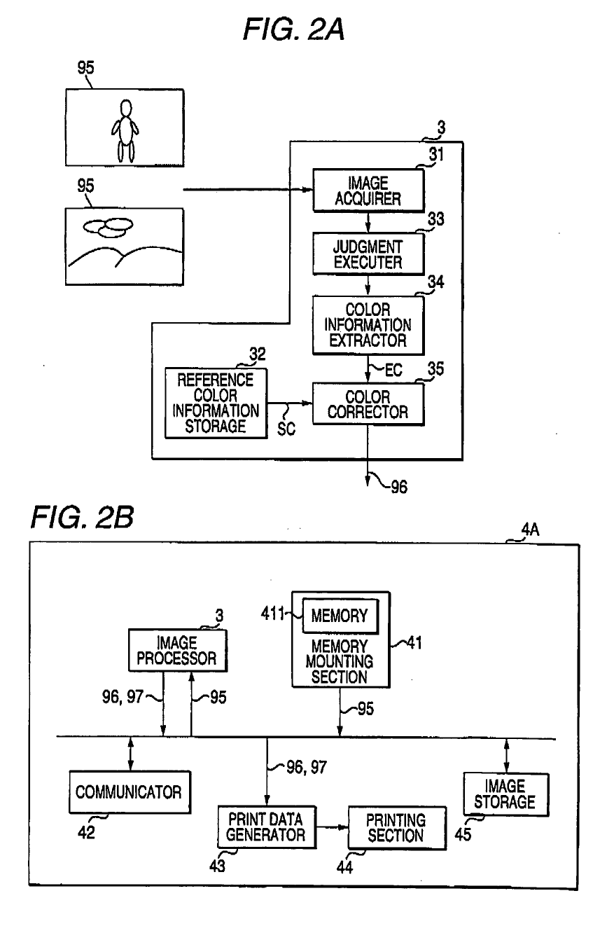

As shown in FIG. 2A, an image processor 3 for color correction comprises an image acquirer 31, a reference color information storage 32, a judgment executer 33, a color information extractor 34, and a color corrector 35.

The image acquirer 31 can acquire an image 95 to be processed. The reference color information storage 32 stores reference color information SC of a face.

The judgment executer 33 can judge whether or not the position information of the face object (the position information F(xf, yf) on the image 95) is written or buried in the image 95. If it is judged that the position information of the face object is written or buried in the image 95, the image 95 is the captured image 92 provided with face object information having the above-described image data structure.

When the judgment executer 33 judges that the position information of the face object (the position information F(xf, yf) on the image 95) is written or buried in the image 95, the color information extractor 34 can extract color information EC of a region indicated by the position information F(xf, yf) of the face object from the image 95.

If the position information F(xf, yf) is plural in number, color information EC corresponding to the position information is extracted and a mean value of the color information is used for the color correction.

The color corrector 35 can generate a color-corrected image 96 by correcting color of the image 95 (that is, the captured image 92 provided with face object information) based on the color information EC extracted by the color information extractor 34 and the reference color information SC stored in the reference color information storage 32. In this case, the color corrector 35 does not perform the color correction when the color information EC and the reference color information SC are similar to each other in a color space, while performing the color correction when the color information EC and the reference color information SC are distant from each other in the color space.

As shown In FIG. 2B, the image processor 3 for color correction may be equipped in a printer 4A. In FIG. 2B, the printer 4A comprises a memory mounting section 41, a communicator 42, a print data generator 43, a printing section 44 and an image storage 45, in addition to the image processor 3.

The memory mounting section 41A is mounted with a memory 411 in which an image is stored. As shown in FIG. 2B, the memory 411 is typically the memory 261 mounted on the memory mounting section 26 of the digital camera 2A shown in FIG. 1B, but is not limited to this (for example, may be a memory mounted on a memory slot of a computer).

The image stored in the memory 411 may be the captured image (the captured image 92 provided with face object information) having the above-described image data structure, or an image not having the above-described image data structure (for example, in case where the memory 411 is the memory mounted on the memory slot of the computer, the image may be a document, a graphic or a picture without being limited to the captured image).

The communicator 42 can communicate with the communicator 27 and the like of the digital camera 2A to receive the image shown in FIG. 1B. This image may also be the captured image (the captured image 92 provided with face object information) having the above-described image data structure, or an image not having the above-described image data structure. This image is stored in the image storage 45.

In addition, although it is shown in FIG. 2B that the image processor 3 includes both of the memory mounting section 41 and the communicator 42, the image processor 3 may be either the memory mounting section 41 or the communicator 42.

The image processor 2 acquires the image 95 from the memory mounting section 41 or the communicator 42 to perform the processing explained with reference to FIG. 2A.

When the image processor 3 judges that the acquired image 95 is the captured image 92 provided with face object information having the above-described image data structure, the print data generator 43 generates print data of the image 96 color-corrected by the color corrector 35 and the printing section 44 prints the print data.

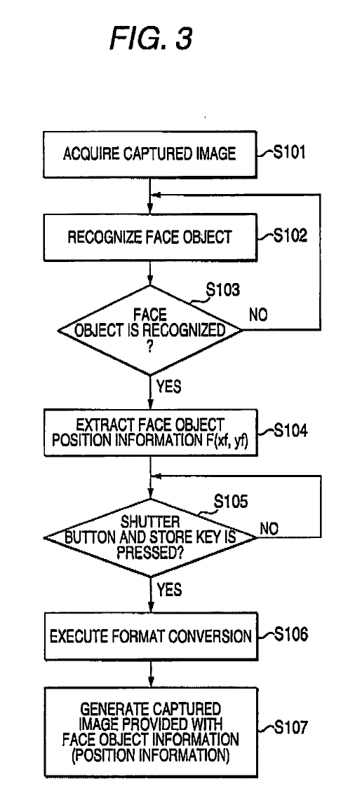

Hereinafter, a generating method of the captured image 92 provided with face object information in the digital camera 2A shown in FIG. 1B will be described with reference to a flowchart shown in FIG. 3.

In this embodiment, the digital camera 2A is set to a image capturing mode and the image processor 1 is assumed to be in an operable (active) state.

The image capturer 21 displays the original captured image 91 changing in a real time manner on the display 25, and the original captured image acquirer 11 acquires the original captured image 91 from the image capturer 21 (S101).

The face object recognizer 12 scans the original captured image 92 and recognizes the face object in the original captured image 91 (S102). In this embodiment, a face object extracting function of the automatic focusing processor 23 is, as it is, used as the face object recognizer 12.

If the face object recognizer 12 does not recognize the face object in the original captured image 91 (NO in S103), the processing returns to 8102. If the face object recognizer 12 recognizes the face object 911 in the original captured image 91 (YES in S103), the face object information extractor 13 extracts the position information F(xf, yf) of the face object 911 in the original captured image 91 on the original captured image 91 (S104).

When the shutter button of the operating section 24 is pushed and the storage key to store the original captured image 91 is pushed (YES in S105), the captured image processor 22 converts the original captured image 91 into an image having a prescribed format (JPEG in this embodiment) (S106). The captured image generator 14 generates the captured image 92 provided with face object information by writing the position information F(xf, yf) in a header of this JPEG image or burying the position information F(xf, yf) as a digital watermarking in the JPEG image (S107).

The captured image 92 provided with face object information is stored in the memory 261 mounted on the memory mounting section 26.

In addition, the memory 261 in which the captured image 92 provided with face object information is stored is detached from the memory mounting section 26 and is mounted on the memory mounting section 41 of the printer 4A (a memory mounted on the memory mounting section 41 is denoted by a reference numeral 411). The captured image 92 provided with face object information stored in the memory 261 is stored in the image storage 45 of the printer 4A via the communicator 27 and the communicator 42 of the printer 4A.

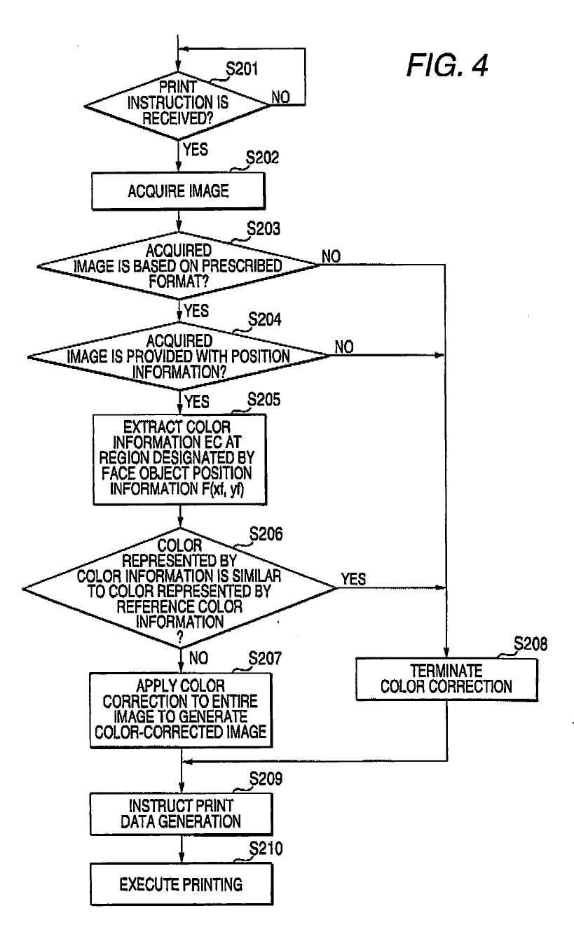

Hereinafter, a color correcting method of the captured image 92 provided with face object information in the printer 4A shown in FIG. 2B will be described with reference to a flowchart shown in FIG. 4.

In this embodiment, the printer 4A is set to a color correction mode and the image processor 3 is assumed to wait for a print instruction in an operable (active) state (S201).

If there is no print instruction (NO in S201), the image acquirer 31 continues to be in a standby state. If there is an instruction to print the image 95 stored in the memory 411 mounted on the memory mounting section 41 or an instruction to print the image stored in the image storage 45 via the communicator 42 (YES in S201), the image acquirer 31 acquires the image instructed to be printed (the image 95 to be processed) (S202).

The judgment executer 33 judges whether or not the image 95 is an image having a prescribed format (for example, a JPEG image) (S203). If it is judged that the image 95 is not the JPEG image (NO in S203), the color correction is terminated (S208). In addition, the print data generator 43 generates the print data of the image 95 (S209) and the printing section 44 prints the print data (that is, the image 95) (S210).

In addition, an image which is not the color-corrected image 96 is represented as a normal image 97 in FIG. 2B.

In addition, upon determining that the image 95 is the JPEG image (YES in S203), the judgment executer 33 judges whether or not the position information of the face object (the position information F(xf, yf) on the image 95) is written or buried in the image 95 (S204). If it is judged that the position information of the face object (the position information F(xf, yf) on the image 95) is not written or buried in the image 95 (NO in S204), the color correction is terminated (S208). Then, the print data generator 43 generates the print data of the image (S209) and the printing section 44 prints the print data (that is, the image 95) (S210).

If the judgment executer 33 judges in the step 8204 that the position information of the face object (the position information F(xf, yf) on the image 95) is written or buried in the image 95 (YES in 8204), the color information extractor 34 extracts the color information EC of a region indicated by the position information F(xf, yf) of the face object from the image 95 (S205).

Subsequently, the color corrector 35 compares the color information EC extracted by the color information extractor 34 with the reference color information SC stored in the reference color information storage 32 and performs the color correction processing. The color correction may be made in an RGB color space, an L*a*b* color space, or a YMC or YMCK color space In this embodiment, the color correction is made in the RGB color space.

It is judged whether or not a color ec(Rec, Gec, Bec) indicated by the color information EC is included in a prescribed region in the RGB color space centered at a color se(Rsc, Gsc, Bsc) indicated by the reference color information SC (S206).

For example, the following conditions are determined for the color ec(Rec, Gec, Bec) indicated by the color information EC.

| | |
|---|---|
| Rsc − δR < Rec ≦ Rsc + δR | (1a) |
| Gsc − δG < Gec ≦ Gsc + δG | (1b) |
| Bsc − δB < Bec ≦ Bsc + δB | (1c) |

If the color ec(Rec, Gec, Bec) satisfies the above conditions, and if the color ec(Rec, Gec, Bec) indicated by the color information EC is included in the prescribed region in the RGB color space centered at the color sc(Rsc, Gsc, Bsc) indicated by the reference color information SC (YES in S206), the color correction is terminated (S208).

If the color ec(Rec, Gec, Bec) indicated by the color information EC is not included in the prescribed region in the RGB color space centered at the color sc(Rsc, Gsc, Bsc) indicated by the reference color information SC (NO in S206), the color-corrected image 96 is generated by entirely correcting the image 95 using a suitable correction method such as tone curve correction or level correction (S207).

The color-corrected image 96 is transmitted to the print data generator 43 and the print data generator 43 generates the print data from the color-corrected image 96 (S209), transmits the generated print data to the printing section 44 in which the image 95 is printed (S210), as described above.

Next, a second embodiment of the present invention will be described.

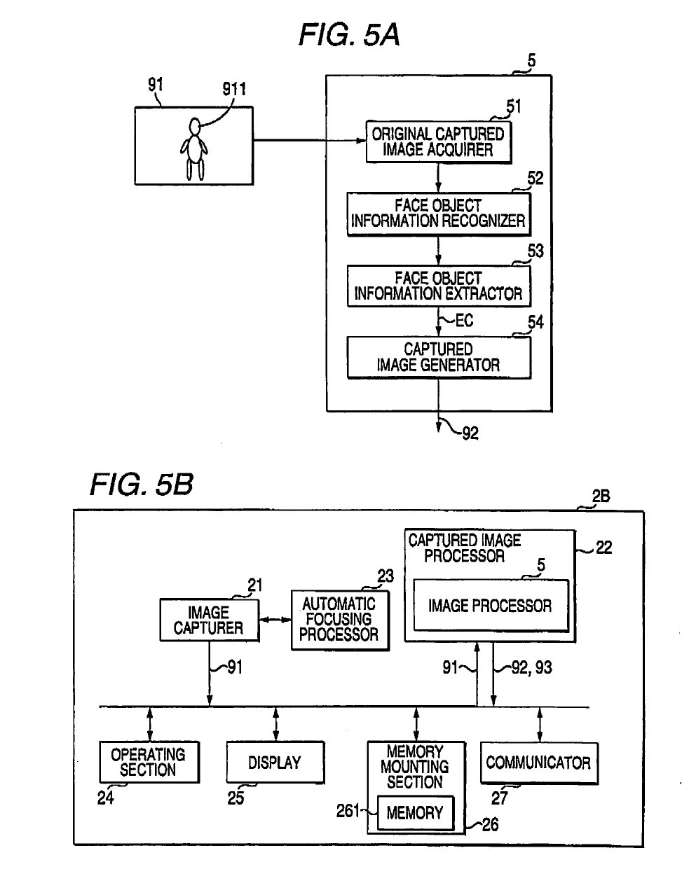

As shown in FIG. 5A, an image processor 5 for generating a captured image provided with face object information includes an original captured image acquirer 51, a face object recognizer 52, a face object information extractor 53, and a captured image generator 54.

For example if the image processor 5 is equipped in a digital camera, the original captured image acquirer 51 can acquire an original captured image from an image capturer 21 of a digital camera 2B (see FIG. 5B).

The face object recognizer 52 can recognize a face object 911 of a person in the original captured image 91.

The face object information extractor 53 can extract color information EC of the face object 911 on the original captured image 91.

The captured image generator 54 can generate a captured image 92 provided with face object information in which the color information is attached to or buried in the original captured image 91.

As shown in FIG. 5B, the image processor 5 may be equipped in the digital camera 2B. The digital camera 2B has substantially the same configuration as the digital camera 2A shown in FIG., 1B.

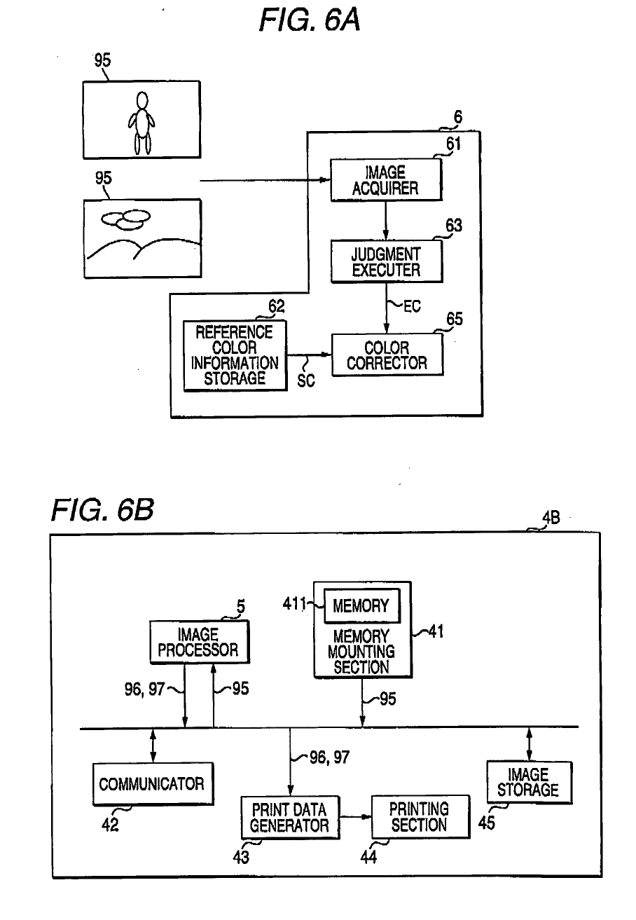

As shown in FIG. 6A, an image processor 6 for color correction includes an image acquirer 61, a reference color information storage 62, a judgment executer 63, and a color corrector 65.

The image acquirer 61 can acquire an image 95 to be processed.

The reference color information storage 62 stores reference color information SC of a face.

The judgment executer 33 can judge whether or not the color information EC is written or buried in the image 95. If it is judged that the color information is written or buried in the image 95, the image 95 is the captured image 92 provided with face object information having the above-described image data structure.

The color corrector 65 can generate a color-corrected image 96 by color-correcting the image 95 (that is, the captured image 92 provided with face object information) based on the color information EC and the reference color information SC stored in the reference color information storage 62. In this case, the color corrector 65 does not perform the color correction when the color information EC and the reference color information SC are similar to each other in a color space, while performing the color correction when the color information EC and the reference color information SC are distant from each other in the color space.

As shown in FIG. 6B, the image processor 6 for color correction may be equipped in a printer 4B. The printer 4B has substantially the same configuration as the printer 4A shown In FIG. 2B.

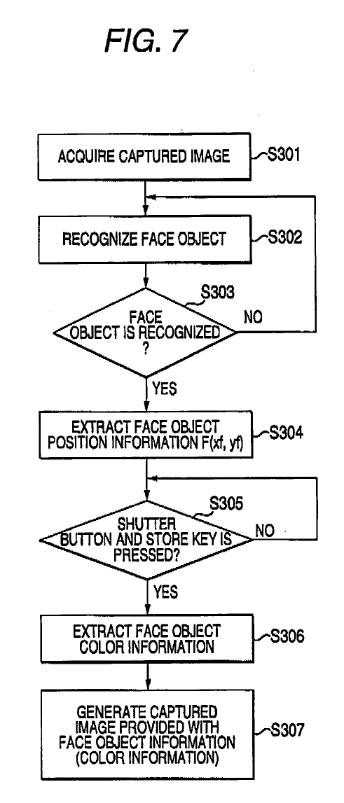

Hereinafter, a generating method of the captured image 92 provided with face object information in the digital camera 2B shown in FIG. 5B will be described with reference to a flowchart shown in FIG. 7.

In this embodiment, the digital camera 2B is set to a image capturing mode and the image processor 5 is assumed to be in an operable (active) state.

The image capturer 21 displays the original captured image 91 changing in a real time manner on the display 25, and the original captured image acquirer 51 acquires the original captured image 91 from the image capturer 21 (S301).

The face object recognizer 52 scans the original captured image 91 and recognizes the face object in the original captured image 91 (S302). In this embodiment, a face object extracting function of the automatic focusing processor 23 is, as it is, used as the face object recognizer 52.

If the face object recognizer 52 does not recognize the face object in the original captured image 91 (NO in S303), the processing returns to S302. If the face object recognizer 52 recognizes the face object 911 in the original captured image 91 (YES in S303), the face object information extractor 53 extracts position information F(xf, yf) of the face object 911 in the original captured image 91 on the original captured image 91 (S304).

When the shutter button of the operating section 24 is pushed and the storage key to store the original captured image 91 is pushed (YES in S305), the captured image processor 22 converts the original captured image 91 into an image having a prescribed format (JPEG in this embodiment) and extracts color information of the face object (S306). The captured image generator 54 generates the captured image 92 provided with face object information by burying the color information as a digital watermarking in this JPEG image (S307). In this embodiment, the face object information is the color information.

The captured image 92 provided with face object information is stored in the memory 261 mounted on the memory mounting section 26.

In addition, the memory 261 in which the captured image 92 provided with face object information is stored is detached from the memory mounting section 26 and is mounted on the memory mounting section 41 of the printer 4B (a memory mounted on the memory mounting section 41 is denoted by a reference numeral 411). The captured image 92 provided with face object information stored in the memory 261 is stored in the image storage 45 of the printer 4B via the communicator 27 and the communicator 42 of the printer 4B.

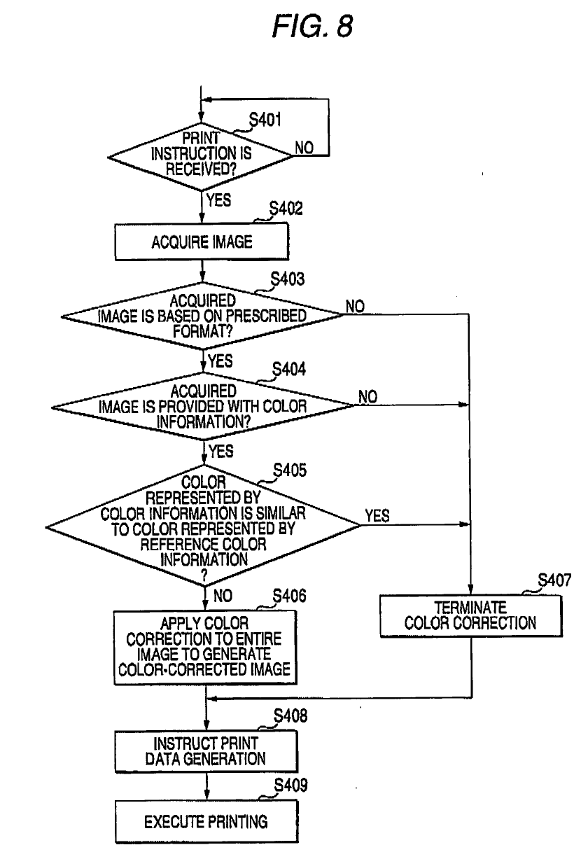

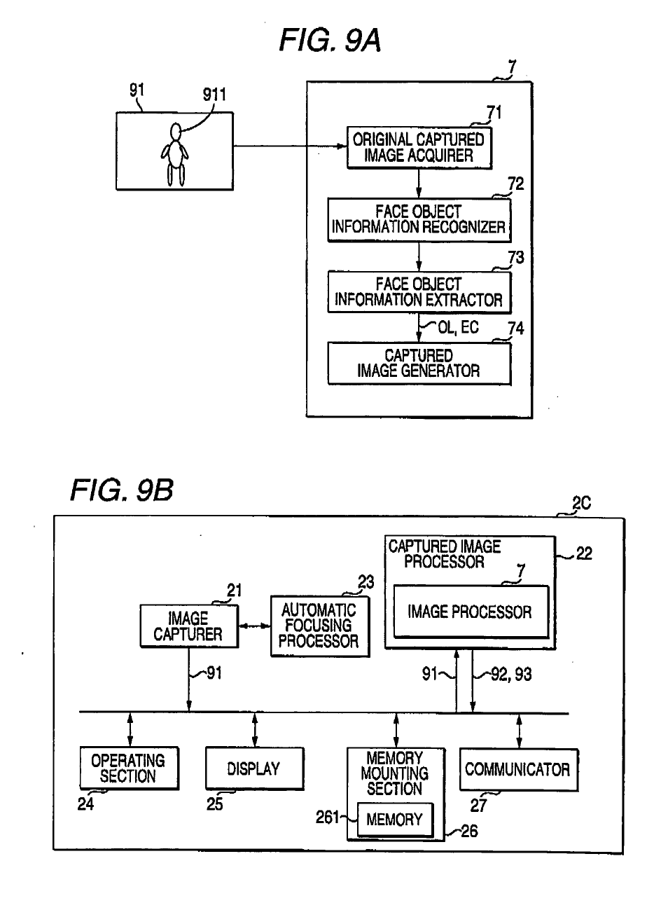

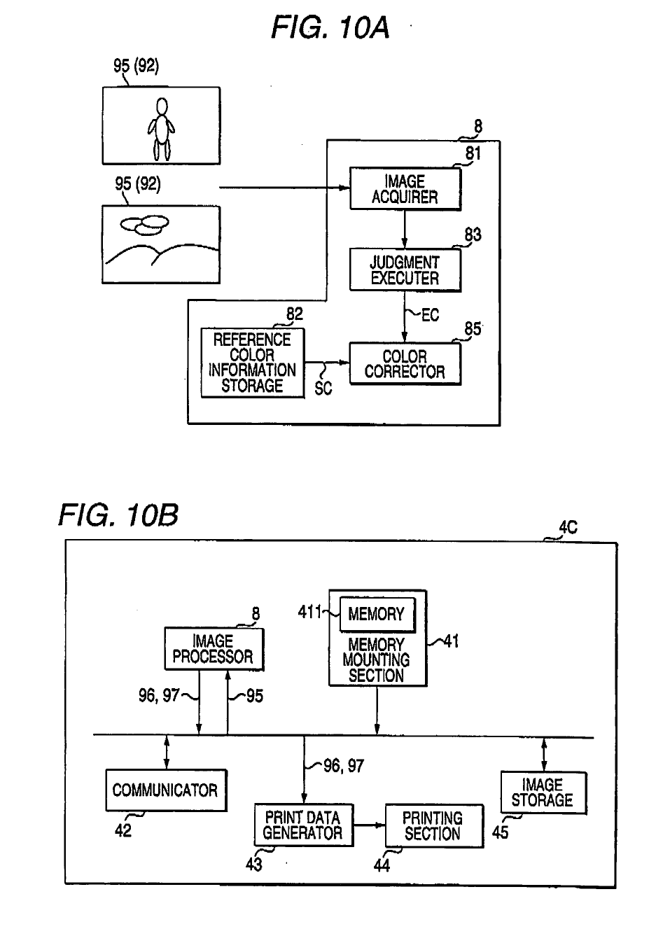

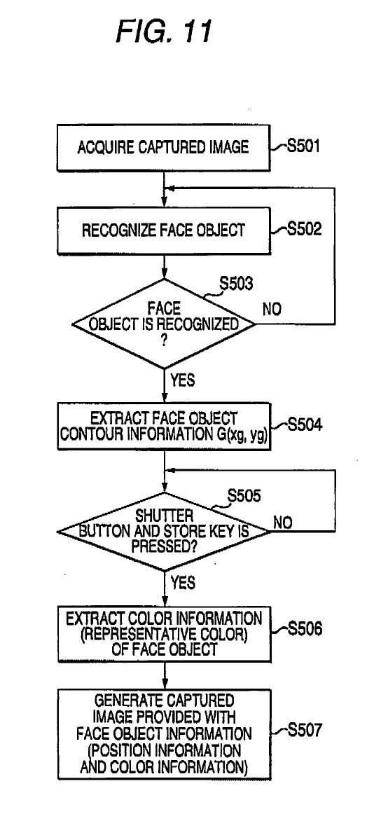

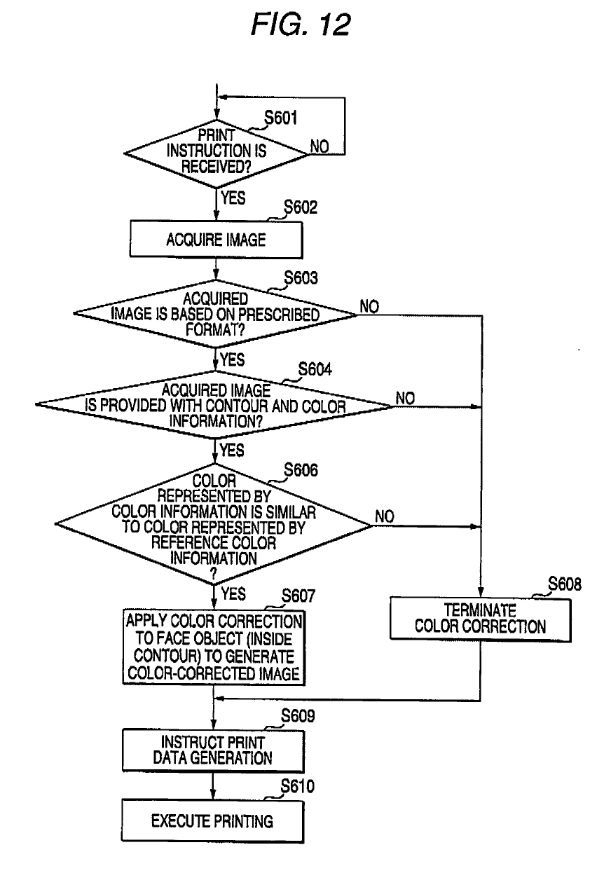

Hereinafter, a color correcting method of the captured image 92 provided with face object information in the printer 4B shown in FIG. 9B will be described with reference to a flowchart shown in FIG. 8.

In this embodiment, the printer 4B is set to a color correction mode and the image processor 6 is assumed to wait for a print instruction in an operable (active) state (S401).

If there is no print instruction (NO in S401), the image acquirer 61 continues to be in a standby state. If there is an instruction to print the image 95 stored in the memory 411 mounted on the memory mounting section 41 or an instruction to print the image stored in the image storage 45 via the communicator 42 (YES in S401), the image acquirer 61 acquires the image instructed to be printed (the image 95 to be processed) (S402).

The judgment executer 33 judges whether or not the image 95 is an image having a prescribed format (a JPEG image in this embodiment) (S403). If it is judged that the image 95 is not the JPEG image (NO in S403), the color correction is terminated (S407). Then, the print data generator 43 is instructed to generate the print data of the image 95 (S408) and the printing section 44 prints the print data (that is, the image 95) (S409).

In addition, an image which is not the color-corrected image 96 is represented as a normal image 97 in FIG. 6B.

In addition, upon determining that the image 95 is the JPEG image (YES in S403), the judgment executer 63 judges whether or not the color information EC of the face object is written or buried in the image 95 (S404). If it is judged that the color information EC of the face object is not written or buried in the image 95 (NO in S404), the color correction is terminated (S407). Then, the print data generator 43 is instructed to generate the print data of the image (S408) and the printing section 44 prints the print data (that is, the image 95) (S409).

If the judgment executer 63 judges that the color information EC of the face object is written or buried in the image 95 (YES in S404), the color corrector 65 compares the color information EC extracted by the color information extractor 34 with the reference color information SC stored in the reference color information storage 62 and performs the color correction processing.

Similar to the first embodiment, the color correction may be made in an RGB color space, an L*a*b* color space, or a YMC or YMCK color space. In the second embodiment, it is judged whether or not a color ec(Rec, Gec, Bec) indicated by the color information EC is included in a prescribed region in the RGB color space centered at a color sc(Rsc, Gsc, Bsc) indicated by the reference color information SC (S405).

For example, the following conditions are determined for the color ec(Rec, Gec, Bec) indicated by the color information EC.

| | |
|---|---|
| Rsc − δR < Rec ≦ Rsc + δR | (1a) |
| Gsc − δG < Gec ≦ Gsc + δG | (1b) |
| Bsc − δB < Bec ≦ Bsc + δB | (1c) |

If the color ec(Rec, Gec, Bec) satisfies the above conditions, and if the color ec(Rec, Gec, Bec) indicated by the color information EC is not included in the prescribed region in the RGB color space centered at the color sc(Rsc, Gsc, Bsc) indicated by the reference color information SC (NO in S405), the color correction is terminated (S407).

If the color ec(Rec, Gec, Bec) indicated by the color information EC is included in the prescribed region in the RGB color space centered at the color sc(Rsc, Gsc, Bsc) indicated by the reference color information SC (YES in S405), the color-corrected image 96 is generated by entirely correcting the image 95 using a suitable correction method such as tone curve correction or level correction (S406).

The color-corrected image 96 is transmitted to the print data generator 43 and the print data generator 43 generates the print data from the color-corrected image 96 (S408), transmits the generated print data to the printing section 44 in which the image 95 is printed (S409).

Next, a third embodiment of the present invention will be described.

As shown in FIG. 9A, an image processor 7 for generating a captured image provided with face object information includes an original captured image acquirer 71, a face object recognizer 72, a face object information extractor 73, and a captured image generator 74.

For example if the image processor 7 is equipped in a digital camera, the original captured image acquirer 71 can acquire an original captured image from an image capturer 21 of a digital camera 2C (see FIG. 9B).

The face object recognizer 72 can recognize a face object 911 of a person in the original captured image 91.

The face object information extractor 73 can extract contour information G(xg, yg) and color information EC of the face object 911 on the original captured image 91.

The captured image generator 54 can generate a captured image 92 provided with face object information in which the contour information G(xg, yg) and the color information is attached to or buried in the original captured image 91.

As shown in FIG. 9B, the image processor 7 may be equipped in the digital camera 2C. The digital camera 2C has substantially the same configuration as the digital camera 2A shown in FIG. 1B.

As shown in FIG. 10A, an Image processor 8 for color correction includes an image acquirer 81, a reference color information storage 82, a judgment executer 83, and a color corrector 85.

The image acquirer 81 can acquire an image 95 to be processed.

The reference color information storage 82 stores reference color information SC of a face.

The judgment executer 83 can judge whether or not the contour information G(xg, yg) and the color information EC of the face object is written or buried in the image 95. If it is judged that the contour information G(xg, yg) and the color information EC is written or buried in the image 95, the image 95 is the captured image 92 provided with face object information having the above-described image data structure.

The color corrector 85 can generate a color-corrected image 96 by color-correcting the face object based on the color information EC and the reference color information SC stored in the reference color information storage 82. In this case, the color corrector 85 does not perform the color correction when the color information EC and the reference color information SC are similar to each other in a color space, while performing the color correction when the color information EC and the reference color information SC are distant from each other in the color space.

As shown in FIG. 10B, the image processor 8 for color correction may be equipped in a printer 4C. The printer 4C has substantially the same configuration as the printer 4A shown in FIG. 2B.

Hereinafter, a generating method of the captured image 92 provided with face object information in the digital camera 2C shown in FIG. 9B will be described with reference to a flowchart shown in FIG. 11.

In this embodiment, the digital camera 2C is set to a image capturing mode and the image processor 7 is assumed to be in an operable (active) state.

The image capturer 21 displays the original captured image 91 changing in a real time manner on the display 25, and the original captured image acquirer 71 acquires the original captured image 91 from the image capturer 21 (S501).

The face object recognizer 72 scans the original captured image 91 and recognizes the face object in the original captured image 91 (S502). In this embodiment, a face object extracting function of the automatic focusing processor 23 is, as it is, used as the face object recognizer 72.

If the face object recognizer 72 does not recognize the face object in the original captured image 91 (NO in S503), the processing returns to S502. If the face object recognizer 72 recognizes the face object 911 in the original captured image 91 (YES In S503), the face object information extractor 73 extracts the contour information G(xg, yg) of the face object 911 in the original captured image 91 on the original captured image 91 (S504).

When the shutter of the operating section 24 is pushed and the storage key to store the original captured image 91 is pushed (YES in S505), the captured image processor 22 converts the original captured image 91 into an image having a prescribed format (JPEG in this embodiment) and extracts color information of the face object (S506). The face object information-attached captured image generator 74 generates the captured image 92 provided with face object information by writing the color information in a header of this JPEG image or burying the color information as a digital watermarking in the JPEG image (S507). In this embodiment, the face object information is the contour information G(xg, yg) and the color information EC.

The captured image 92 provided with face object information is stored in the memory 261 mounted on the memory mounting section 26.

In addition, the memory 261 in which the captured image 92 provided with face object information is stored is detached from the memory mounting section 26 and is mounted on the memory mounting section 41 of the printer 4C (a memory mounted on the memory mounting section 41 is denoted by a reference numeral 411). The captured image 92 provided with face object information stored in the memory 261 is stored in the image storage 45 of the printer 4C via the communicator 27 and the communicator 42 of the printer 4C.

Hereinafter, a color correcting method of the captured image 92 provided with face object information in the printer 4C shown in FIG. 10B will be described with reference to a flowchart shown in FIG. 12.

In this embodiment, the printer 4C is set to a color correction mode and the image processor 8 is assumed to wait for a print instruction in an operable (active) state (S601).

If there is no print instruction (NO in S601), the image acquirer 81 continues to be in a standby state. If there is an instruction to print the image 95 stored in the memory 411 mounted on the memory mounting section 41 or an instruction to print the image stored in the image storage 45 via the communicator 42 (YES in S601), the image acquirer 81 acquires the image instructed to be printed (the image 95 to be processed) (S602).

The judgment executer 83 judges whether or not the image 95 is an image having a prescribed format (a JPEG image in this embodiment) (S603). If it is judged that the image 95 is not the JPEG image (NO in S603), the color correction is terminated (S607). Then, the print data generator 43 is instructed to generate the print data of the image 95 (S608) and the printing section 44 prints the print data (that is, the image 95) (S609).

In addition, an image which is not the color-corrected image 96 is represented as a normal image 97 in FIG. 10B. In addition, upon determining that the image 95 is the JPEG image (YES in S602), the judgment executer 63 judges whether or not the contour information G(xg, yg) and the color information EC of the face object is written or buried in the image 95 (S604). If it is judged that the contour information G(xg, yg) and the color information EC of the face object is not written or buried in the image 95 (NO in S604), the color correction is terminated (S607). Then, the print data generator 43 is instructed to generate the print data of the image (S608) and the printing section 44 prints the print data (that is, the image 95) (S609).

If the judgment executer 83 judges that the contour information G(xg, yg) and the color information EC of the face object is written or buried in the image 95 (YES in S604), the color corrector 85 compares the color information EC with the reference color information SC stored in the reference color information storage 82 and performs the color correction processing.

Similar to the first and second embodiments, the color correction may be made in an RGB color space, an L*a*b* color space, or a YMC or YMCK color space. In the third embodiment, it is judged whether or not a color ec(Rec, Gec, Bec) indicated by the color information EC is included in a prescribed region in the RGB color space centered at a color sc(Rsc, Gsc, Bsc) indicated by the reference color information SC (S605).

For example, the following conditions are determined for the color ec(Rec, Gec, Bec) indicated by the color information EC.

| | |
|---|---|
| Rsc − δR < Rec ≦ Rsc + δR | (1a) |
| Gsc − δG < Gec ≦ Gsc + δG | (1b) |
| Bsc − δB < Bec ≦ Bsc + δB | (1c) |

If the color ec(Rec, Gec, Bec) satisfies the above conditions, and if the color ec(Rec, Gec, Bec) indicated by the color information EC is not included in the prescribed region in the RGB color space centered at the color sc(Rsc, Gsc, Bsc) indicated by the reference color information SC (NO in S605), the color correction is terminated (S608). If the color ec(Rec, Gec, Bec) indicated by the color information EC is included in the prescribed region in the RGB color space centered at the color sc(Rsc, Gsc, Bsc) indicated by the reference color information SC (YES in S605), the color-corrected image 96 is generated by correcting a region indicated by the contour information G(xg, yg) using a suitable correction method such as tone curve correction or level correction (S607).

The color-corrected image 96 is transmitted to the print data generator 43 and the print data generator 43 generates the print data from the color-corrected image 96 (S609), transmits the generated print data to the printing section 44 in which the image 95 is printed (S610).

In addition, the image processor of the invention and the digital camera of the invention may be equipped with a function to determine a human race in the face object. For example, the white race, the yellow race and the black race may be determined depending on a facial contour, feature arrangement, complexion and a facial skeleton, and, when the color correction is made, disposition of the complexion of the human race may be extracted, and the complexion may be determined considering the disposition. In addition, the digital camera may be equipped with a function to set the human race. The reference color information of the face may be set depending on countries. For example, the reference color of a face of a northern European may be set to be different from the reference color of a face of a person who lives in an equatorial country. The digital camera may be equipped with a function to select the reference color information depending on the human race or the like so that a user can select a reference color properly.

The present invention is not limited to the above described embodiments and may be practiced in various forms without departing from the spirit and scope of the invention.

The disclosure including the specification, the drawings, and the claims in Japanese Patent Application No. 2006-34603, filed on Feb. 10, 2006 is incorporated herein by reference.

What is claimed is:

1. A method of generating image data, comprising:
generating image data including an object by capturing an image;
recognizing the object included in the image data automatically;
extracting information regarding the object automatically; and
associating the information regarding the object with the image data after a storing operation of the image data is instructed.

2. The method as set forth in claim 1, wherein:
the object is a face.

3. The method as set forth in claim 1, wherein:
the information is either information indicative of a position of the object in the image or information indicative of color of the object.

4. The method as set forth in claim 1, further comprising:
storing the image data with which the information has been associated in a removable memory.

5. An image processor, comprising:
an data acquirer, operable to acquire original image data;
a recognizer, operable to recognize a face object included in the original image data;
an information extractor, operable to extract either position information of the face object or color information of the face object, as face object information; and
a data generator, operable to generate image data by either attaching the face object information to the original image data or burying the face object information in the original image data.

6. A color correction method, comprising:
acquiring an image to be processed;
judging whether color information of a face object is attached to or buried in the image; and
applying color correction to the image based on the color information in a case where it is judged that the color information is attached to or buried in the image.

7. The color correction method as set forth in claim 6, wherein:
in a case where there are a plurality of face objects, the color correction is applied based on the respective color information attached to the face object.

8. The color correction method as set forth in claim 6, wherein:
the image is acquired from a removable memory.
